(19) United States
(12) Patent Application Publication
(10) Pub. No.: US 2016/0202138 A1
(43) Pub. Date: Jul. 14, 2016

(54) Self-Cleaning Particle Filter in a Sniffer Probe

(71) Applicant: INFICON GMBH, Köln (DE)

(72) Inventor: Daniel Wetzig, Koeln (DE)

(21) Appl. No.: 14/912,526

(22) PCT Filed: Aug. 18, 2014
(86) PCT No.: PCT/EP2014/067584

§ 371 Date: Feb. 17, 2016

(30) Foreign Application Priority Data
Aug. 29, 2013 (DE) 10 2013 217 279.6

(51) Int. Cl. G01M 3/20

(52) U.S. Cl. CPC G01M 3/20

(57) ABSTRACT

The invention relates to a sniffer probe for detecting gas leaks, the probe including a suction gas line which at one end has a suction gas inlet and at an opposite end has a suction gas outlet connectable to a suction device, and a measurement gas line bifurcating from the suction gas line, which measurement gas line at one end has a measurement gas inlet forming the bifurcation and at an opposite end has a measurement gas outlet connectable to a gas detector. The measurement gas inlet has a measurement gas filter arranged in such a way that the suction gas flow guided through the suction gas line to the suction gas outlet is guided along the surface of the measurement gas filter.

Sniffer probes are used in gas leak detection in order to test specimens filled with a gas for a possible gas leak. In doing so, the sniffer probe is passed along the outer side of a specimen and draws (sniffs) gas from the outer side of the specimen. In case of a leak, the gas escaping from the specimen through the leak is also drawn in and is analyzed in a downstream gas detector. The gas detector is typically designed for detecting different kinds of gas and in particular the gas escaping from the specimen.

It is known to provide sniffer probes with a suction gas line and a measurement gas line branching from the suction gas line. Whereas the suction gas line leads from a suction gas inlet to a suction gas outlet connected with a suction device, the measurement gas line branches from the suction gas line and has a measurement gas outlet at its end opposite the branching point, the outlet being connectable with the gas detector. Such a sniffer probe is described in WO 2009/033978 A, for example. Whereas the suction device, which is realized for example as a powerful vacuum pump or a blower, generates a mass flow of a comparatively great mass flow rate in the suction gas line, a partial flow is derived from this mass flow magnitude by means of the measurement gas line and is directed to the gas detector. By means of this sniffer probe, it is possible to detect gas leaks even at large distances using a large taken-in mass flow rate by supplying the gas detector with only the required partial flow of the taken-in mass flow rate.

In leak detection, particle filters are used in the gas-carrying lines so as to protect the gas conveying system and the sensor system from contamination and occlusion. For providing sufficient protection, it is conventionally required to use several filter stages in succession so as to filter the total flow of the air taken in. In this regard it is a basic difficulty that the degree of contamination increases with the increase in the quantity of gas of the gas flow taken in so that the filters become occluded the faster, the larger the gas flow is. The conventional manner of filtering gas thus is a limiting factor in the increase of the gas volume flow taken in.

It is an object of the invention to provide a sniffer probe that can take in a large gas volume flow and comprises an improved gas particle filter.

The sniffer probe of the present invention is defined by the features of claim 1.

The measurement gas inlet which forms the branch of the measurement gas line from the suction gas line, comprises a measurement gas filter arranged such that the suction gas flow directed toward the suction gas outlet through the suction gas line is guided along the surface of the measurement gas filter. Thus, the measurement gas filter is not flown through by the full suction gas flow taken in by the sniffer probe, but merely by the partial flow directed through the measurement gas line to the gas detector. In the process, the suction gas flow is guided along the surface of the measurement gas filter, and the suction gas flow discharges particles filtered out by the measurement gas filter. The suction gas flow thus purges and regenerates the measurement gas filter without the measurement gas filter having to be removed and without the operation of the sniffer probe having to be interrupted. The measurement gas filter does not become clogged as fast as in the conventional filtering of the total gas flow taken in. The intervals between replacements of the gas filter may thereby be extended significantly.

In the region of the branch, the measurement gas filter advantageously forms the inner wall of the suction gas line so as to achieve particularly favorable flow conditions. In this regard, the measurement gas filter may be formed as a cylinder over the entire circumference of the inner wall. It is conceivable to provide an annular gap radially outside the measurement gas filter, which gap is connected with the measurement gas line. Such an arrangement is particularly advantageous with a plate-shaped “carpet probe”. Also with such a sniffer probe, the major part of the air flow taken in is blown out directly and without being filtered, and only a partial flow is branched off and supplied to the gas detector.

While the suction gas flow flows through the suction gas line in the axial direction, it is advantageous if the measurement gas flow flows through the measurement gas filter at least partly in a radial direction from the inside to the outside, so that particles caught by the measurement gas filter can be carried away by the suction gas flow.

Advantageously the mass flow rate of the suction gas flow in the flow direction upstream of the branch of the measurement gas line is between 2,000 sccm and 4,000 sccm and, particularly preferred, about 3,000 sccm. Preferably the volume flow of the measurement gas flow is between 200 sccm and 400 sccm and more preferably about 300 sccm. “About” means a variation of ca. ±10% at most. Thus, the proportion of the measurement gas flow may represent about 10% of the suction gas flow taken in. Preferably this proportion is in a range between 0.5 and 0.01 times the mass flow rate of the suction gas taken in.

The gas inlet may be provided with an inlet filter having a pore size that is large enough to not significantly affect the mass flow magnitude taken in and to avoid a fast clogging of the filter. In the region downstream of the branch of the measurement gas line, the suction gas line may have a suction gas filter arranged in the flow direction, the filter allowing a large gas flow and does not significantly affect the same. This filter may be connected with a capillary or hose-like supply of the suction gas flow leading to a pump, for example.

Two embodiments of the invention will be explained in detail hereinafter with reference to the drawings. In the Figures:

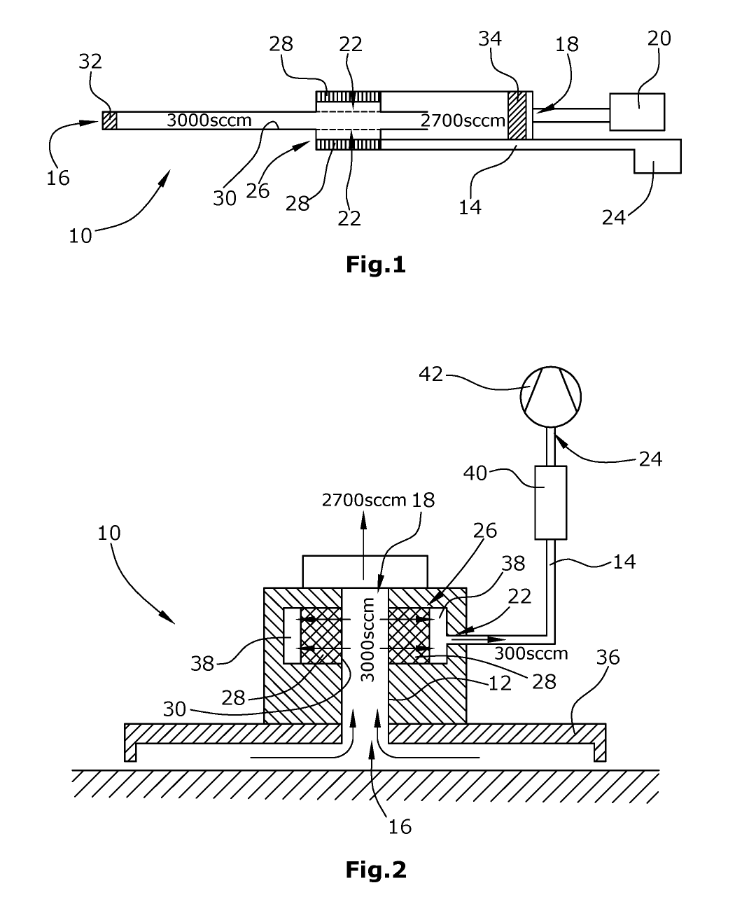

FIG. 1 shows the first embodiment, and

FIG. 2 shows the second embodiment.

First, the common aspects of the two embodiments will be described:

The sniffer probe 10 has a suction gas line 12 and a measurement gas line 14 branching from the suction gas line 12. One of the ends of the suction gas line 12 is provided with a suction gas inlet 16 for sucking the gas. At its end opposite the suction gas inlet, the suction gas line 12 is provided with a suction gas outlet 18 that serves to connect a suction device 20. In the embodiment shown in FIG. 1, the suction device 20 is a vacuum pump. In the embodiment shown in FIG. 2, the suction device 20, which is not illustrated in the Figure for reasons of simplicity, may be a blower (fan) or a pump.

The measurement gas line 14 branches from the suction gas line 12. The measurement gas line 14 is provided with a measurement gas inlet 22 at its end connected with the suction gas line 12, while its end opposite the measurement gas inlet 22 is provided with a measurement gas outlet 24. The measurement gas outlet 24 serves to connect a measurement gas detector. The measurement gas detector, which is not illustrated in either Figure for reasons of simplicity, may be a mass spectrometer or another selective gas detection system, respectively.

The measurement gas inlet 22 forms the branch 26 of the measurement gas line 14 from the suction gas line 12. The measurement gas inlet 22 is provided with a measurement gas filter 28. The measurement gas filter 28 is respectively tubular in shape, the inner surface of the measurement gas filter 28 forming the inner wall 30 of the suction gas line 12 in the region of the branch 26.

The suction device 20 draws a suction gas flow of about 3,000 sccm through the suction gas inlet 16. The suction gas flow is directed along the inner side of the measurement gas filter 28 in the axial direction of the suction gas line 12 to the suction gas outlet 18 thereof and is supplied from there to the suction device 20. In the region of the branch 26, a partial flow branches from the suction gas flow, the partial flow flowing through the measurement gas inlet 22 and through the measurement gas filter 28 into the measurement gas line 14. This partial flow is the measurement gas flow that is supplied to the gas detector, not illustrated in the Figures, through the measurement gas line 14 and the measurement gas outlet 24. Gas proportions present in the measurement gas flow are detected by the gas detector. The measurement gas filter 28 prevents an intrusion of interfering particles or contaminations into the measurement gas line 14. The particles trapped by the measurement gas filter 28 are carried away by the comparatively strong suction gas flow and are transported towards the suction gas outlet 18.

The differences between the two embodiments will be explained hereunder:

FIG. 1 shows a sniffing leak detector with a hand-held sniffing tip. The suction gas inlet 16 is provided with an inlet filter 32 and the suction gas outlet is provided with an outlet filter 34. The two filters 32, 34 are large-pored filters for trapping only large particles, whereas the measurement gas filter 28 is a fine-pored filter. The filters 32 only negligibly affect the suction gas flow.

In FIG. 2 the sniffer probe 10 is a so-called “carpet probe” with a large-sized suction plate 36, the suction gas line 12 branching at the centre of the plate and having its suction gas inlet 16 provided at the same. An annular gap 38 is formed radially outside the measurement gas filter 28. The measurement gas flow branched from the suction gas flow flows radially from the inside out through the measurement gas filter 28 and is then supplied in the circumferential direction to the measurement gas line 14 through the annular gap, the measurement line being in gas-carrying communication with the gap 38. The measurement gas line 14 has a flow throttle 40 for flow limitation and is connected with a vacuum pump 42 that forms a part of the gas detector.

1. A sniffer probe for detecting gas leaks, comprising a suction gas line which at its one end has a suction gas inlet and at an opposite end has a suction gas outlet connectable to a suction device, and further comprising a measurement gas line branching from the suction gas line, which measurement gas line at its one end has a measurement gas inlet forming a branch and at an opposite end has a measurement gas outlet connectable to a gas detector,
wherein
the measurement gas inlet has a measurement gas filter arranged such that a suction gas flow guided through the suction gas line to the suction gas outlet is guided along a surface of the measurement gas filter.

2. The sniffer probe of claim 1, wherein the measurement gas filter forms a tube inner wall of the suction gas line in the region of the branch.

3. The sniffer probe of claim 1, wherein the measurement gas filter is cylindrical.

4. The sniffer probe of claim 3, wherein an annular gap is formed radially outside the measurement gas filter.

5. The sniffer probe of claim 1, wherein the suction gas flow is directed in the axial direction through the suction gas line and the measurement gas filter is, at least in part, flown through radially from the inside out.

6. The sniffer probe of claim 1, wherein the suction gas flow in the flow direction upstream of the branch is between 2,000 sccm and 4,000 sccm.

7. The sniffer probe of claim 1, wherein a volume flow of a measurement gas flow is between 200 sccm and 400 sccm.

8. The sniffer probe of claim 1, wherein a volume velocity of a measurement gas flow is in a range from 0.01 to 0.5 times and preferably about 0.1 times the suction gas flow.

9. The sniffer probe of claim 1, wherein the measurement gas filter is fine-pored, having a pore size of 1 μm at most.

10. The sniffer probe of claim 1, wherein the suction gas inlet has an inlet filter.

11. The sniffer probe of claim 10, wherein the inlet filter has a pore size of about 10 μm.

12. The sniffer probe of claim 1, wherein the suction gas line has an outlet filter downstream of the branch, seen in the flow direction.

13. The sniffer probe of claim 12, wherein a pore size of the outlet filter is about 10 μm.

14. The sniffer probe of claim 6, wherein the suction gas flow in the flow direction upstream of the branch is about 3,000 sccm.

15. The sniffer probe of claim 7, wherein the volume flow of the measurement gas flow is about 300 sccm.
